(19) United States
(12) Patent Application Publication
(10) Pub. No.: US 2009/0083757 A1
(43) Pub. Date: Mar. 26, 2009

(54) COMPUTER SYSTEM AND PROGRAM PLUG-IN MANAGEMENT METHOD THEREOF

(75) Inventor: Lai-Chen Lai, Hsinchu (TW)

Correspondence Address: APEX JURIS, PLLC, 12733 LAKE CITY WAY NORTHEAST, SEATTLE, WA, 98125, US

(73) Assignee: MITAC TECHNOLOGY CORP., Hsinchu (TW)

(21) Appl. No.: 12/323,869

(22) Filed: Nov. 26, 2008

Related U.S. Application Data
(63) Continuation-in-part of application No. 11/156,623, filed on Jun. 21, 2005, now abandoned.

(51) Int. Cl. G06F 9/54; G06F 3/048

(52) U.S. Cl. 719/312; 715/769

(57) ABSTRACT

A computer system with window-based OS (Operating System) and a program plug-in management method is provided. Even though a non-plug-in application installed in the computer system is originally incapable of plugging into a target program, through the method, certain non-plug-in application will still be plugged into the desired target program. A plug-in management table is constructed in advance to store frame information of an assigned frame within the window of the target program and plug-in information of the non-plug-in application and the target program. The non-plug-in application will be plugged into the assigned frame within the window of the target program according to the plug-in management table. After activated, the non-plug-in application and the target program will be executed in parallel so that the non-plug-in application will remain in the window of the target program without shrinking into a bottom toolbar or disappearing from the window.

This application is continuation-in-part application of U.S. patent application Ser. No. 11/156,623, filed Jun. 21, 2005 and hereby incorporates the content of this application by reference.

### FIELD OF THE INVENTION

The present invention relates to a method for program plug-in operation on a window-based operating system and, more particularly, to a method for plugging a non-plug-in application into a frame within the window of a target program.

### BACKGROUND OF THE INVENTION

As the software development progresses rapidly, the window-based personal computer (PC) software is widely used in offices, households and other business locations.

One of the most popular current PC software applications is word processing program, such as the well-known software Microsoft Office WORD. While using the word processing program, it is sometimes necessary to open up other small non-plug-in tool applications, such as “Calculator” and “Calendar” on the operation system Microsoft Windows. In the case of opening the small non-plug-in tool programs upon operation of the word processing program, a frame or a pop-up window is opened to display the small tool application(s) “on” the window of the word processing program. Since the small non-plug-in tool application is not originally built with the plug-in function to be plugged into the window of the word processing program, the small tool application can be executed solely without engaging with the operation of the word processing program.

However, without the plug-in function, the small tool application usually disappears from the window of the word processing program. One example is when the user clicks on the window of the word processing program with the small non-plug-in tool application popped out “on” the window of the word processing program, the small non-plug-in tool application will shrink to the bottom tool bar (such as “Calculator” or “Calendar” of Microsoft Windows). Another example is if a non-target program is actuated upon operation of both the small non-plug-in tool application and the word processing program, the small non-plug-in tool application and the word processing program will disappear from the screen together. However, when the user next clicks on the tool bar to open the word processing program, the non-plug-in tool application does no longer exist on the window of word processing program. Instead, the non-plug-in tool application remains on the tool bar unless the user clicks it to pop up again. The two problems mentioned above may cause much inconvenience, and reduces the efficiency of work.

### SUMMARY OF THE INVENTION

The present invention is provided to overcome the aforementioned drawback of the current technology. The present invention is mainly to provide a method for program plug-in management of a non-plug-in application on a computer system so that when using a target program (such as word processing program) together with the non-plug-in application, the non-plug-in application can remain embedded in a frame within the window of the target program after the user finishes using a non-target program A proposed plug-in management program is operable with storage and learning capability to execute the method of the present invention. The non-plug-in application can be automatically actuated according to the actuation/operation of the target program and can be adjusted into a proper frame size corresponding to the window of the word processing program.

In an embodiment of the present invention, A program plug-in management method is provided to be performed on a computer system. The computer system has one more non-plug-in application and one or more target program; wherein both of the non-plug-in application and the target program are installed under a window-based operating system and the non-plug-in application is originally incapable of plugging into the target program. The method includes the steps of: constructing a plug-in management table that records plug-in information of the non-plug-in application and the target program, as well as frame information of an assigned frame within a window of the target program; executing the non-plug-in application upon activation of the target program according to the plug-in management table; and plugging the non-plug-in application into the assigned frame within the window of the target program according to the plug-in management table.

In an embodiment of the present invention, a computer system includes: a window-based operating system installed thereon; one or more target program installed under the operating system; one or more non-plug-in application installed under the operating system, wherein the non-plug-in application is originally installed incapable of plugging into the target program: and a plug-in management table recording plug-in information of the non-plug-in application and the target program, as well as frame information of an assigned frame within a window of the target program. the computer system is adapted to execute the non-plug-in application upon activation of the target program according to the plug-in management table, and the computer system is adapted to plug the non-plug-in application into the assigned frame within the window of the target program according to the plug-in management table.

In comparison to the conventional techniques, the present invention overcomes the problem of a non-plug-in application disappearing from the window of the target program when opening a non-target program. In addition, the present invention provides a management method including a customizable plug-in management table. The plug-in management table includes the name of the target program and non-plug-in application, the fields of a plug-in frame number, location of (the frame for) the non-plug-in application, foreground size of the non-plug-in application, and the path addressing the non-plug-in application. The path of non-plug-in application points to an actuation file of the non-plug-in application. The plug-in frame number, the location of the frame of the target plug-in program, the foreground size of the non-plug-in application, and the path of the non-plug-in application and the target program can all be customized to meet individual user's convenience.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 is a block diagram of a computer system that performs a program plug-in management method according to the present invention;

FIG. 2 shows an explanatory flowchart of a program plug-in management method regarding the processes of constructing a plug-in management table according to a first embodiment of the present invention;

FIG. 3 shows an explanatory flowchart of a program plug-in management method according to a second embodiment of the present invention;

FIG. 4 shows a schematic view of the plug-in management table of the present invention; and

FIG. 5 shows a schematic view of the window of the target program displayed on the display of the computer system according to the present invention.

### DETAILED DESCRIPTION OF PREFERRED EMBODIMENT

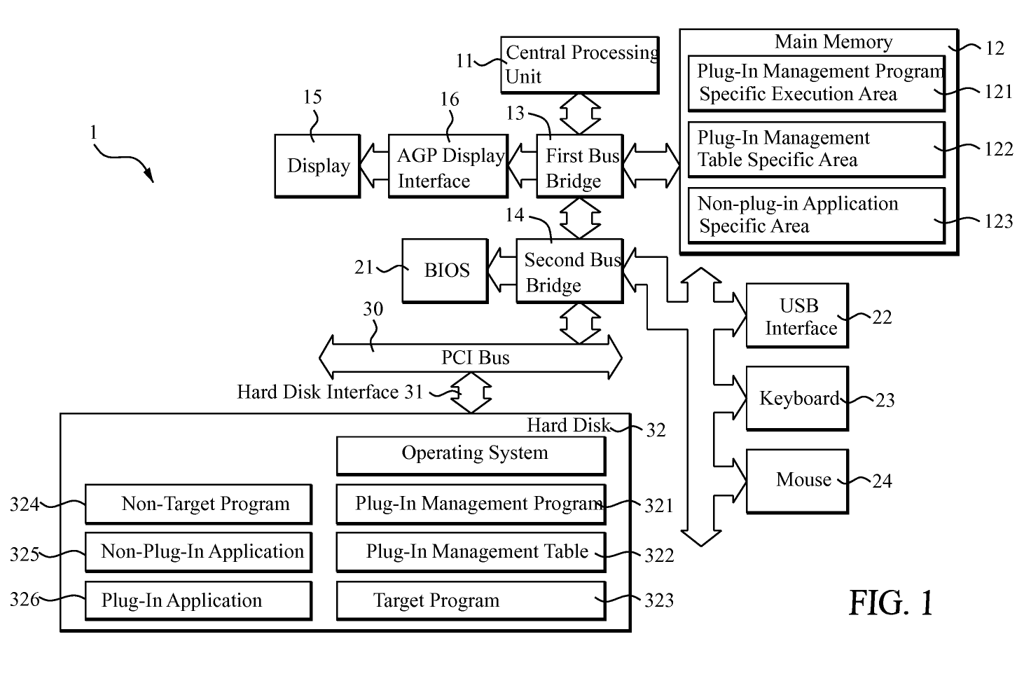

With reference to the drawings and in particular to FIG. 1, which shows a block diagram of a computer system that performs a program plug-in management method according to the present invention. A computer system 1 mainly includes a central processing unit (CPU) 11, a main memory 12, a first bus bridge 13, and a second bus bridge 14; said four elements constitute a computer main structure “computer host” through the internal system bus of the computer system.

The first bus bridge 13, which is also referred to as “north bridge”, is connected to an AGP display interface 16 and a display 15.

The main memory 12 provides storage spaces such as a plug-in management program specific execution area 121 fast access of the CPU 11 when executing a plug-in management program 321, a plug-in management table specific area 122 fast access of the CPU 11 when accessing a plug-in management table 322, and a non-plug-in application specific area 123 for fast access of the CPU 11 when executing a target program 323. The arrangement of the storage spaces within the main memory 12 is controlled by the first bus bridge 13 (or memory controller) and depends on how the CPU 11 uses the main memory 12; such arrangement is not limited to the present embodiment.

The second bus bridge 14, which is also referred to as “south bridge”, is in bus connection with a BIOS 21, a USB interface 22, a keyboard 23, a mouse 24, and a PCI bus 30. The PCI bus 30 is connected to a hard disk interface 31, and a hard disk 32. The hard disk 32 stores programs, applications and data such as plug-in management program 321, plug-in management table 322, target program 323, a non-target program 324, non-plug-in application 325 and plug-in application 326.

In the present invention, the programs and applications mentioned above is specifically defined hereinafter. The plug-in management program 321 is defined as computer-executable software that performs the program plug-in method of the present invention. The steps and procedures of the program plug-in method 321 will be further described in the following sections.

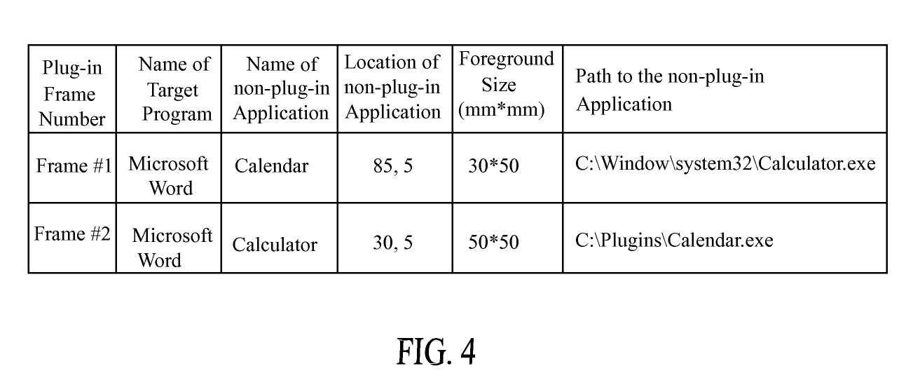

The plug-in management table 322 is a computer readable data sheet with certain but not limited format. The items and interrelations of the information stored within the plug-in management table 322 will be further described in FIG. 4 and in the following sections. The plug-in management table 322 is mainly used by the plug-in management program 321 while executing the steps and procedures of the program plug-in method 321.

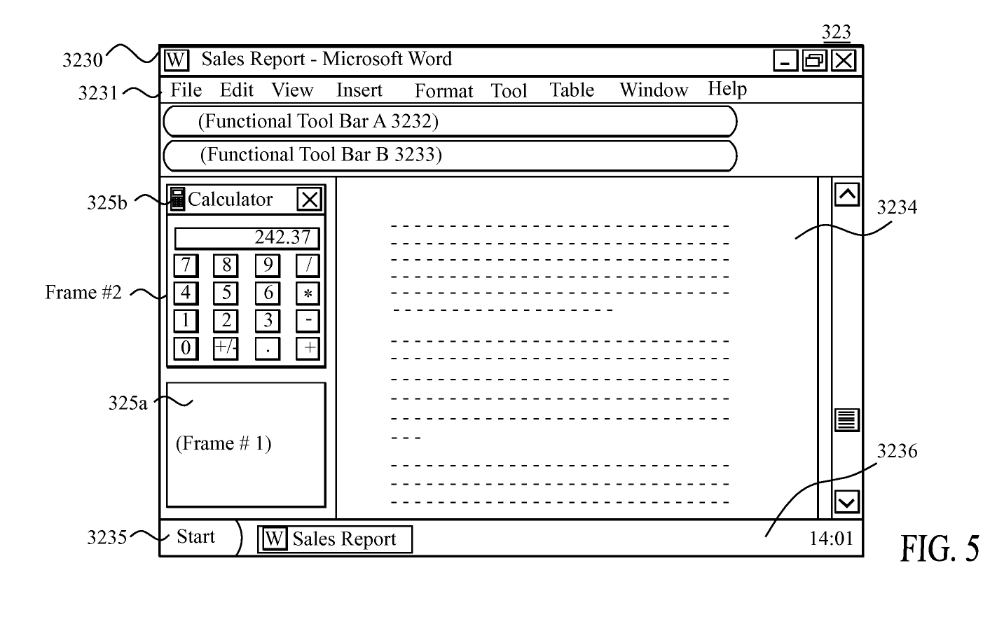

The target program 323 is a software suit (such as Microsoft Office WORD) that is installed under window-based OS (Operating System, such as Microsoft Windows) of the computer system 1. Generally the target program 323 performs certain groups of relative functions such as word processing, photo editing and etc. In the present invention, the window 3230 of the target program 323 displayed on the display 15 (see FIG. 5) is where the plug-in management program 321 plugs the non-plug-in application 325 therein. On the contrary, the non-target program 324 is another software installed under the OS of the computer system 1 but will not be plugged with the non-plug-in application 325 therein.

The non-plug-in application 325 is a small tool software that is built for operating under general environments of the OS, and is not dedicated for embedding or executing specifically within the window of the target program 323, such as “Calculator” or “Calendar” of Microsoft Windows. Such non-plug-in application 325 usually has a very small file size like less than 1 mega bytes as a whole. The non-plug-in application 325 may comprise *.exe file, or other executable batch files or other executable electronic files. On the contrary, the plug-in application 326 is built dedicatedly for embedding into the window of the target program 323. For example, after installed to the OS, software suite Adobe Acrobat provides plugins to various target programs so that *.pdf files may be read upon operation of the target program, such as opening a pdf file within the window of a web browser. Meanwhile, each plugin of Adobe Acrobat is built dedicatedly for a corresponding target program; for instance, usually Adobe Acrobat provides plenty of plugins for different types of target programs respectively.

Aside from being stored in the hard disk 321, the foregoing programs, applications and data may be stored in any computer readable storages, such as an USB flash device or a DVD optical disk.

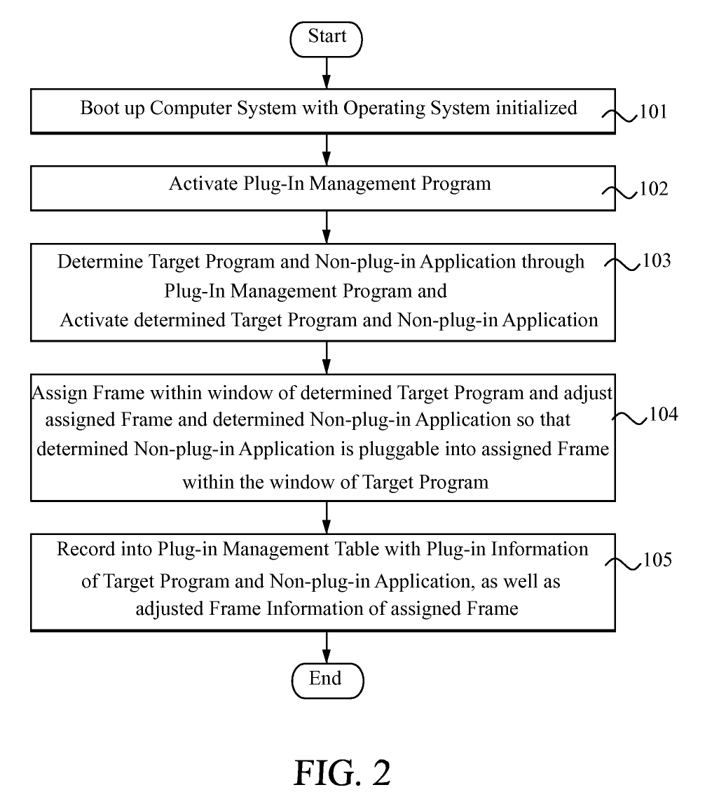

Also referring to FIG. 2, which shows a flowchart of constructing a plug-in management table according to a first embodiment of the present invention, the following description also refers to the plug-in management table shown in FIG. 4, and the displayed window of the target program shown in FIG. 5.

First to construct the plug-in management table, the computer system 1 needs to be booted up with the operating system being initialized (step 101). The user can then activate the plug-in management program 321 (step 102) and next start to build the plug-in management table. In FIG. 5, the window 3230 of a target program 323 “Microsoft Word” is displayed. On the window 3230 of a target program 323, there are menu bar 3231, “functional tool bar A” 3232 and “functional tool bar B” 3233, displayed content 3234 of a opened *.doc file “Sales Report”, START menu 3235, bottom tool bar 3236 and two plug-in frames #1 and #2 with two non-plug-in applications 325a, 325b plugged therein. To achieve such plug-in function between the target program 323 and the two non-plug-in applications 325a, 325b, the plug-in management table needs to be built up in advance and the plug-in management program needs to be executed according to the plug-in management table needs upon the operation of the target program 323.

The plug-in management table in FIG. 4 contains two sets of records. (1) In the first record, the plug-in frame number is frame #1; the name of the target program 323 is Microsoft Word and the name of the non-plug-in application 325a is Calendar; the location of the non-plug-in application 325a is “85, 5” (for example 85 mm in y-axis and 5 mm in x-axis); the foreground size of the plug-in frame #1 is “30*50” (for example 30 mm long and 50 mm wide), and the path addressing the non-plug-in program 325a is for example C:\Plugins\Calendar.exe. (2) In the second record, the plug-in frame number is frame #2; the name of the target program 323 is still Microsoft Word and the name of the non-plug-in application 325b is Calculator; the location of the non-plug-in application 325b is “30, 5” (for example 30 mm in y-axis and 5 mm in x-axis); the foreground size of the plug-in frame #2 is 50-50 (for example 50 mm long and 50 mm wide), and the path addressing the non-plug-in application 325b is C:\Windows\System32\Calculator.exe. The plug-in frame numbers listed in the plug-in management table may be serial numbers of plug-in frames within the window 3230 of the target program 323. It is practical that the path addressing to specific area in the main memory 12 of the computer system 1. Once the non-plug-in application is activated, the non-plug-in application may be resided within the non-plug-in application specific area 123 in the main memory 12 for fast access of CPU 11.

The construction of the plug-in management table further includes several preparation steps. In the first embodiment of the present invention, determine the target program and the non-plug-in application through the plug-in management program 321 and activate the determined target program 323 and the determined non-plug-in application (step 103). Then, through the plug-in management program 321, assign a frame within the window of the target program 323 and adjust the assigned frame and/or the determined non-plug-in application 325 so that the determined non-plug-in application is pluggable into the assigned frame within the window of the target program 323 (step 104); the assigned frame has frame information including its frame number, frame location, frame size and etc. And next, through the plug-in management program 321, record into the plug-in management table with the plug-in information of the target program 323 and the non-plug-in application 325, as well as the adjusted frame information of the assigned frame (step 105). Then, the plug-in management table is finished corresponding to the determined target program 323 and non-plug-in application. The steps disclosed above are not limited to the recited sequences.

In a practical embodiment, regarding assigning the frame, the window of non-plug-in application may be executed with a drag-and-drop operation of a cursor device (such as touch pad, digital pen, touch panel or mouse of the computer system) to be moved to a certain location within the window of the target program, and to plug the non-plug-in application into an automatically-assigned frame around a dropping location where the window of non-plug-in application is dropped thereto. During the plug-in operation according to the plug-in management table disclosed in the present invention, the foreground size of the non-plug-in application will be adjusted to fit in the frame at certain location within the window of the target program.

Generally, the plug-in management program 321 is defined as computer-executable software that performs the program plug-in management method of the present invention; the plug-in management program 321 performs the construction of the plug-in management table and the steps to actually plug the non-plug-in application into the assigned frame within the window of the target program. It is also selectable whether the non-plug-in application is embedded into the window of the target program 323 temporarily or permanently. Namely, the plug-in management table may further include information of plug-in mode that indicates different possible plug-in operations. Some examples of plug-in modes are introduced as follows.

(1) Full plug-in mode: The non-plug-in application 325 is embedded into the frame within the window of the target program 323 ever since the target program 323 is activated. That means the activation of the plug-in management program 321 and the load-in operation of the plug-in management table 322 is correlated to the activation or the on-top operation of the window of the target program 323. The user will not need to manually activate the plug-in management program 321 and load-in the plug-in management table 322 prior to the operation of the target program 323. Here are two situations; one is triggered by the activation of the target program, the other is for the on-top operation, The on-top operation of the window of the target program 323 is defined as that the user clicks on the START menu or the bottom toolbar to activate the target program 323 or switch windows from a non-target program to the activated target program 323, and accordingly the window of the target program 323 is popped up on top of the display 15 (i.e. the window of the target program is currently displayed).

(2) Semi-plug-in mode: The non-plug-in application 325 is, only upon on-top operation of the target program 323, embedded into the frame as a “representative icon” on the functional toolbar within the window of the target program 323. In a practical embodiment, multiple representative icons indicating different non-plug-in applications may be generated on the functional toolbar of the target program. Therefore, the non-plug-in application is embedded into the frame within the window of the target program only when the user clicks the representative icon of the non-plug-in applications on the functional toolbar of the target program.

(3) Manual plug-in mode: The non-plug-in application 325 is temporarily embedded into the frame within the window of the target program 323 only when the non-plug-in application 325 and the target program 323 are both activated. The activation of the plug-in management program 321 and the load-in operation of the plug-in management table 322 may be correlated with the activation of the non-plug-in application 325 or the target program 323. The activated plug-in management program 321 will start to detect whether the non-plug-in application 325 and the target program 323 are both activated, so as to temporarily embed the non-plug-in application 325 into the frame within the window of the target program 323.

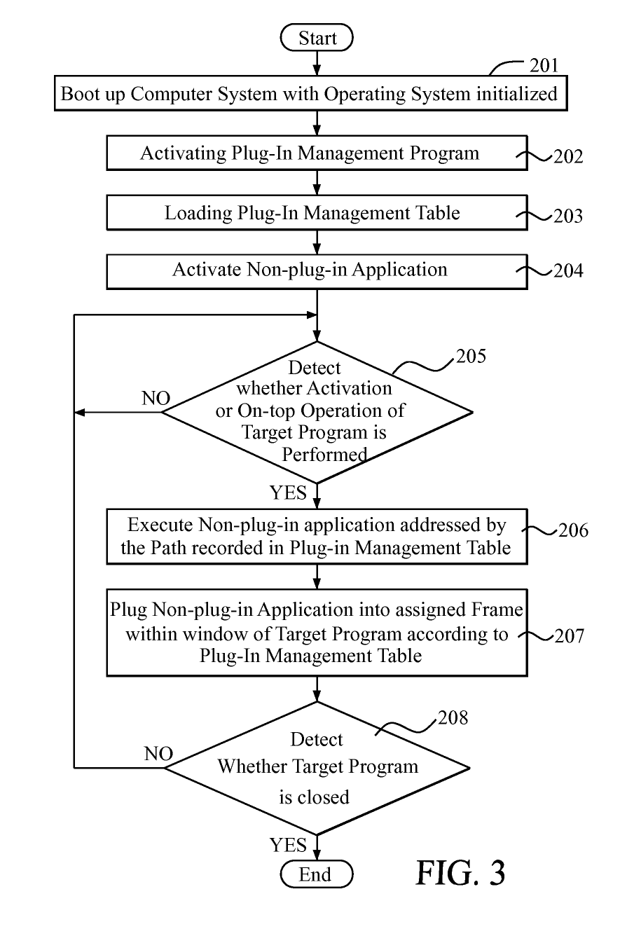

FIG. 3 shows an explanatory flowchart of a program plug-in management method according to a second embodiment of the present invention. The steps disclosed below are not limited to the recited sequences. For sure the foundation environment is that the computer system 1 is booted up with the operating system initialized (step 201). The user can manually activate the plug-in management program 321 (step 202) and loads the plug-in management table 322 built in advance (step 203). Afterwards, activate the non-plug-in application (step 204). If the activation of the plug-in management program 321 and the load-in operation of the plug-in management table 322 are correlated with the activation of the non-plug-in application 325 and/or the target program 323, and if the non-plug-in application is operated in the aforesaid full plug-in mode, steps 202, 203 and 204 will not be manual operations.

Then, the computer system 1 (executing the program plug-in method of the plug-in management program 321) detects whether the actuation or the on-top operation of the target program 323 is performed (step 205). If so, the computer system 1 (performing the program plug-in method of the plug-in management program 321) executes the non-plug-in application addressed by the path recorded in the plug-in management table 322 (step 206). The recorded path in the plug-in management table 322 may point to the file address stored in the hard disk 32 or to the non-plug-in application specific area 123 of the main memory 12. In step 207, the computer system 1 (executing the program plug-in method of the plug-in management program 321) plugs the non-plug-in application 325 into the assigned frame within the window 3230 of the target program 323 according to the frame information recorded in the plug-in management table 322. If multiple records are recorded in the plug-in management table and all corresponding to the same target, such as the two frames shown in FIG. 5, every non-plug-in application will be executed in parallel and be able to remain together within the window of the target program 323.

Then, the computer system 1 will detect whether tithe target program 323 is closed (step 208). If not, the process will return to step 205 and keep detecting.

As a brief, the present invention disclosed a computer system and a program plug-in management method that provide a customized way to plug non-plug-in application into the window of a target program. Therefore, even the non-plug-in application is originally installed in the computer system incapable of plugging into the target program, through the present invention the user may choose certain non-plug-in application and plug into desired target program. Meanwhile, since the non-plug-in application will be executed whenever the target program is performed with the activation or the on-top operation, the non-plug-in application will not disappear from the window of the target program or shrink into the bottom toolbar. Besides, if multiple non-plug-in applications are recorded in the plug-in management table to be plugged into the same target program, every non-plug-in application may be selectively executed in parallel and be able to remain together within the window of the target program.

While the invention has been described in connection with what is presently considered the best mode for carrying out the present invention, it is to be understood that the invention is not to be limited to what is disclosed above, but on the contrary, is intended to cover various modifications and equivalent arrangement included within the spirit and scope of the appended claims.

What is claimed is:

1. A program plug-in management method performed on a computer system, the computer system having at least one non-plug-in application and at least one target program, wherein both of the non-plug-in application and the target program are installed under a window-based operating system and the non-plug-in application is originally incapable of plugging into the target program, the method comprising the steps of:
constructing a plug-in management table that records plug-in information of the non-plug-in application and the target program, as well as frame information of an assigned frame within a window of the target program;
executing the non-plug-in application upon activation of the target program according to the plug-in management table; and
plugging the non-plug-in application into the assigned frame within the window of the target program according to the plug-in management table.

2. The method as claimed in claim 1, wherein the step of constructing the plug-in management table comprises the steps of:
determining and activating the non-plug-in application and the target program;
assigning the frame within the window of the target program and adjusting the non-plug-in application to fit in the frame within the window of the target program; and
recording into the plug-in management table with the plug-in information of the target program and the non-plug-in application, as well as the frame information of the assigned frame.

3. The method as claimed in claim 2, wherein the frame is assigned through the step of executing a drag-and-drop operation to move window of the non-plug-in application to a certain location within the window of the target program and plug the non-plug-in application into the frame around a dropping location where the window of non-plug-in application is dropped thereto.

4. The method as claimed in claim 1, wherein the frame information of the assigned frame within the window of the target program comprises data selected from the group consisting of plug-in frame number, location of the assigned frame and foreground size of the non-plug-in application.

5. The method as claimed in claim 1, wherein the plug-in information of the plug-in management table comprises data selected from the group consisting of name of the target program, name of the non-plug-in application and a path addressing the non-plug-in program.

6. The method as claimed in claim 5, wherein the non-plug-in program is resided within a non-plug-in application specific area of a main memory of the computer system, and the path addressing the non-plug-in program points to the non-plug-in application specific area of the main memory.

7. The method as claimed in claim 5, wherein the path addressing the non-plug-in program points to a file address stored in a hard disk of the computer system.

8. The method as claimed in claim 1, wherein the step of plugging the non-plug-in application into the assigned frame comprises a step of adjusting foreground size of the non-plug-in application to fit in the assigned frame within the window of the target program.

9. The method as claimed in claim 1, wherein the non-plug-in application is executed either upon the activation of the target program, or executed upon an on-top operation of the target program.

10. The method as claimed in claim 1, wherein at least another one non-plug-in application is recorded in the plug-in management table and corresponding to the target program as well, and the non-plug-in applications are selectively executed in parallel and are able to remain together within the window of the target program.

11. A computer system, comprising:
a window-based operating system installed thereon;
at least one target program installed under the operating system;
at least one non-plug-in application installed under the operating system, wherein the non-plug-in application is originally installed incapable of plugging into the target program:
a plug-in management table, recording plug-in information of the non-plug-in application and the target program, as well as frame information of an assigned frame within a window of the target program; and
wherein the computer system is adapted to execute the non-plug-in application upon activation of the target program according to the plug-in management table, and the computer system is adapted to plug the non-plug-in application into the assigned frame within the window of the target program according to the plug-in management table.

12. The computer system as claimed in claim 11, wherein the plug-in management table is constructed through adapting the computer system to determine and activate the non-plug-in application and the target program, and through adapting the computer system so that the frame within the window of the target program is assigned and the non-plug-in application is adjust to fit in the frame within the window of the target program, and thereby the plug-in management table is recorded with the plug-in information of the target program and the non-plug-in application, as well as the frame information of the assigned frame.

13. The computer system as claimed in claim 12, wherein the frame is assigned through executing a drag-and-drop operation to move window of the non-plug-in application to a certain location within the window of the target program and plug the non-plug-in application into the frame around a dropping location where the window of non-plug-in application is dropped thereto.

14. The computer system as claimed in claim 11, wherein the frame information of the assigned frame within the window of the target program comprises data selected from the group consisting of plug-in frame number, location of the assigned frame and foreground size of the non-plug-in application.

15. The computer system as claimed in claim 11, wherein the plug-in information of the plug-in management table comprises data selected from the group consisting of name of the target program, name of the non-plug-in application and a path addressing the non-plug-in program.

16. The computer system as claimed in claim 15, wherein the non-plug-in program is resided within a non-plug-in application specific area of a main memory of the computer system, and the path addressing the non-plug-in program points to the non-plug-in application specific area of the main memory.

17. The computer system as claimed in claim 15, wherein the path addressing the non-plug-in program points to a file address stored in a hard disk of the computer system.

18. The computer system as claimed in claim 11, wherein the computer system is adapted to adjust foreground size of the non-plug-in application to fit in the assigned frame within the window of the target program.

19. The computer system as claimed in claim 11, wherein the non-plug-in application is executed either upon the activation of the target program, or executed upon an on-top operation of the target program.

20. The computer system as claimed in claim 11, wherein at least another one non-plug-in application is recorded in the plug-in management table and corresponding to the target program as well, and the non-plug-in applications are selectively executed in parallel and are able to remain together within the window of the target program.
